(19) United States
(12) Patent Application Publication
(10) Pub. No.: US 2013/0049347 A1
(43) Pub. Date: Feb. 28, 2013

(54) APPARATUS FOR VIEWING PAGES

(71) Applicant: Whoman BAHRAMI, Washington, DC (US)

(72) Inventor: Whoman BAHRAMI, Washington, DC (US)

(21) Appl. No.: 13/600,193

(22) Filed: Aug. 30, 2012

Related U.S. Application Data
(60) Provisional application No. 61/528,784, filed on Aug. 30, 2011.

(51) Int. Cl. B42D 9/00

(52) U.S. Cl. 281/45

(57) ABSTRACT

The present invention includes a pageprop device including a retaining wall, a base and, in some embodiments stabilizing tab, which can be used by a user to view a page of bound material in a “hands free” manner. In addition, the angle between the beginning portion of the retaining wall and the beginning portion of the base is selected to ensure that sufficient light is displayed on the page of the bound material that is of interest to the user. Rectangular wedges are used to fix this angle.

### RELATED APPLICATIONS

This application claims priority to U.S. Provisional Application No. 61/528,784 which was filed on Aug. 30, 2011 and which is herein incorporated in its entirety by reference.

### TECHNICAL FIELD OF THE INVENTION

The present invention relates generally to an apparatus used to separate and hold pages of a file folder, notepad, or similar item (“bound material”) open for an unobstructed view by a user.

### BACKGROUND OF THE INVENTION

When a user attempts to view or use information contained in bound material it is typically difficult for the user to hold the bound material open and to take notes or type the information into a computer. Generally, the user is required to use one hand to keep the bound material open and displaying the correct page thereby making the act of taking notes or typing information into a computer difficult.

### SUMMARY OF THE INVENTION

There is a need for a hands free device which would hold bound material open for easy reference for a user. This invention solves that need with an apparatus which is used to separate and hold open pages in bound material. The apparatus of the invention is placed between the pages of the bound material and permits the user to have an unobstructed view of the selected page while both of the user's hands remain free to perform other tasks such as taking notes, opening other documents, or typing information into a computer via a computer keyboard.

### BRIEF DESCRIPTION OF THE DRAWINGS

In the drawings, like reference characters generally refer to the same parts throughout the different views. The drawings are not necessarily to scale, rather emphasis is generally being placed upon illustrating the principles of various embodiments. The foregoing and other aspects of the invention will be better understood from the following description of embodiments of the invention, by way of example only, and with reference to the accompanying drawings, in which:

FIGS. 1A & 1B show various views of the pageprop device 100;

FIG. 2 shows the various portions of the pageprop device 100;

FIGS. 3A and 3B show a side view and a back view of the pageprop device 100 respectively.

### DETAILED DESCRIPTION OF THE INVENTION

In the following detailed description, reference will be made in detail to the preferred embodiments of the present invention, examples of which are illustrated in the accompanying drawings, which form a part hereof and show, by way of illustration, embodiments in which the invention may be practiced. These embodiments are described in sufficient detail to enable those skilled in the art to practice the invention, and it is to be understood that other embodiments may be utilized, and that structural, and logical changes may be made without departing from the spirit and scope of the present invention. The progression of processing steps described is exemplary of embodiments of the invention; however, the sequence of steps is not limited to that set forth herein and may be changed as is known in the art, with the exception of steps necessarily occurring in a certain order.

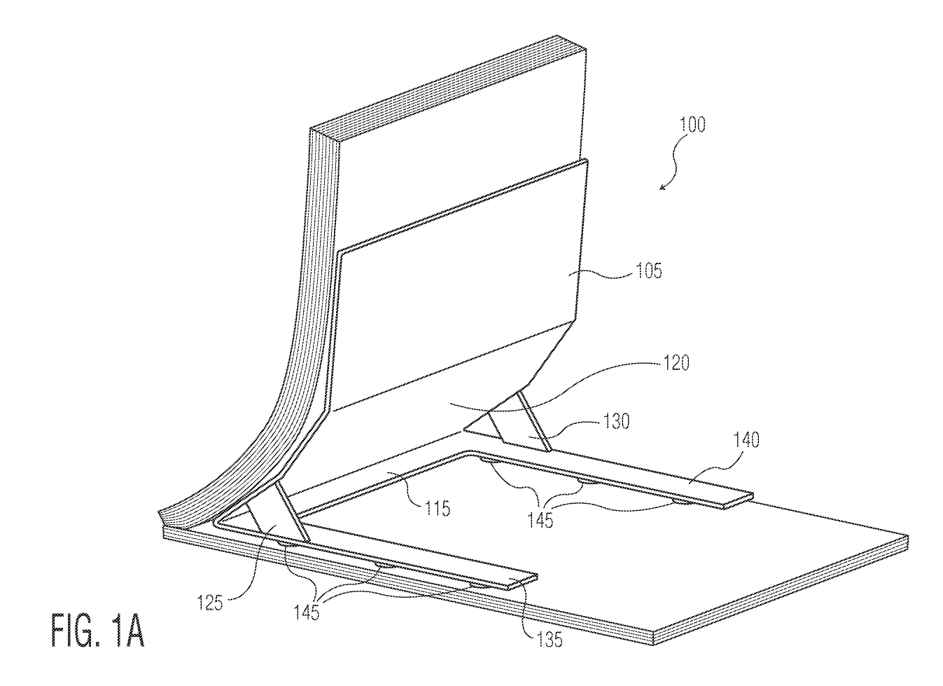

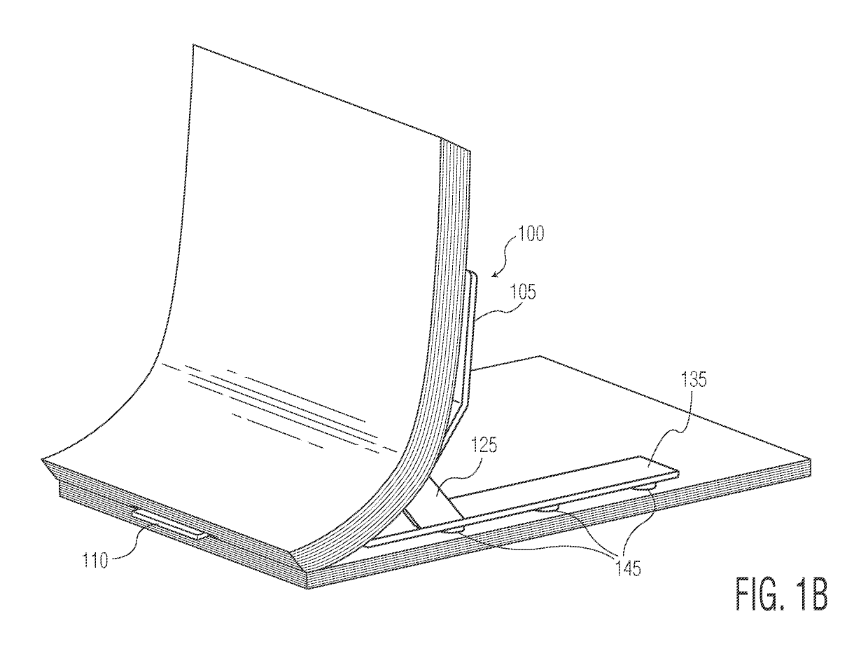

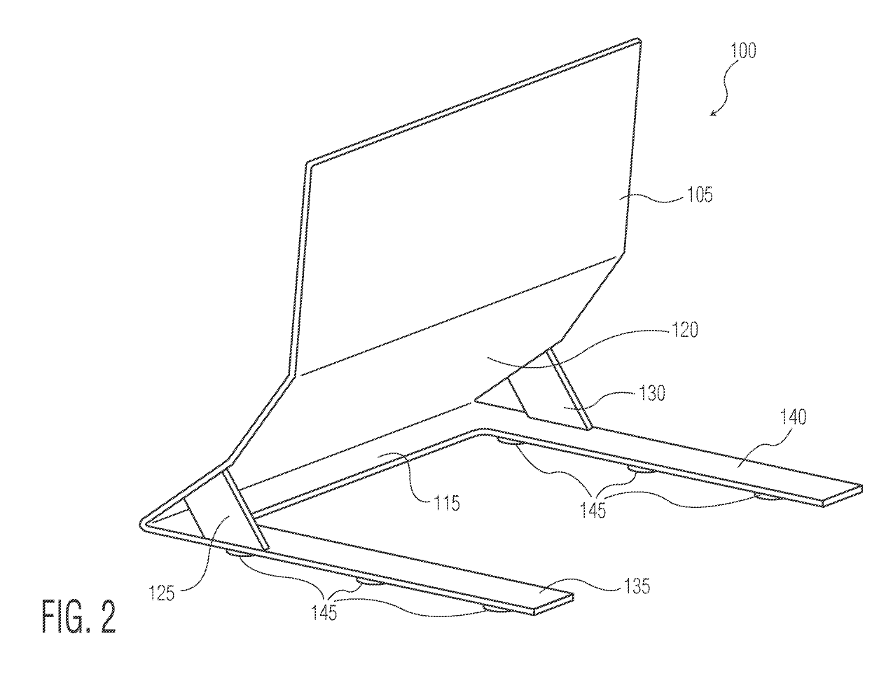

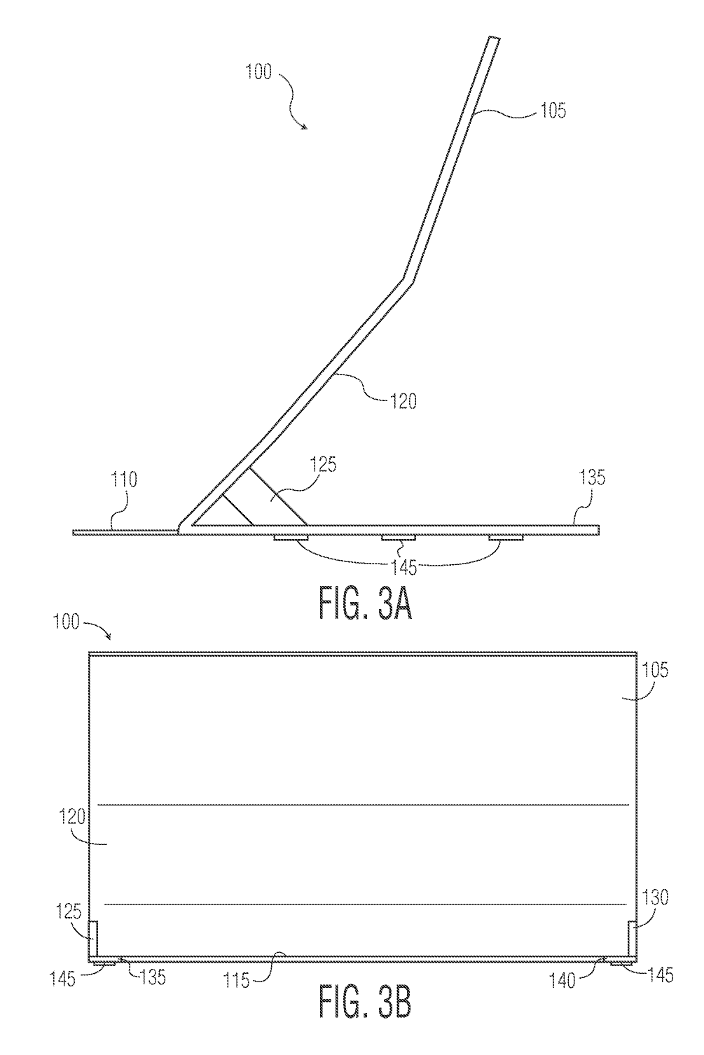

Referring to FIGS. 1-3, in one embodiment of the invention the pageprop device 100 includes a retaining wall (or page retainer) 105, a stabilizing tab 110, and a base 115. In this embodiment, the retaining wall 105 of the pageprop device would be curved (or segmented) such that the pages that are not of interest to the user would be out of the user's view and these unviewed pages would not block the light from reaching the page of interest (or page being viewed) to the user. In this embodiment, one side 120 of the retaining wall 105 is attached to the base 115 and the stabilizing tab 110. In another embodiment, one side 120 of the retaining wall 105 is attached to the base 115 and the base 115 is extended to include a stabilizing tab 110.

The preferred embodiment does not include stabilizing tab 110.

In a preferred embodiment the base 115 includes two rectangular wedges 125, 130 that connect the back portion of the base with the legs (135, 140) of the base. In a preferred embodiment, a footer 145 made of rubber or similar non-slip material is included on the bottom of each leg (135, 140) to reduce the possibility that the legs (135, 140) will slip on the surface of the bound material being viewed. Multiple footers 145 may be included as show in the figures. The angle between the base and the beginning portion of the retaining wall is selected to maximize the light that will be displayed on the surface of the page being viewed while not adversely affecting the binding of the bound material.

In use, when the stabilizing tab 110 is included, the stabilizing tab 110 of the pageprop device 100, is inserted by the user between two pages of the bound material. As the stabilizing tab 110 is inserted between the pages, a page of interest to the user becomes visible between the two legs (135, 140) of the pageprop device 100 and pages that are not of interest to the user slide across the surface of the retaining wall 105. When the stabilizing tab 110 is correctly positioned, the page of interest of the bound material will be viewable by the user between the two legs (135 and 140) of the base 115 while the pages that are not of interest to the user would rest on top of the retaining wall 105.

In a preferred embodiment, the pageprop device 110 is made of sturdy, clear plastic that can hold 20 pounds of weight. In a preferred embodiment, the pageprop device includes an 8½ inch wide U shaped base of clear plastic. The width of 8½ inches corresponds to the width of a standard piece of paper. The clear plastic of the pageprop device ensures that the apparatus does not obstruct the user's view of any of the words on the page being viewed. This U shaped base is stabilized by clear rubber footings (or similar material) located beneath the ends of the U shaped base.

In a preferred embodiment, the three sides of the base 115 are each plastic pieces which are 1 inch in width with each leg (135, 140) being 6 inches in length and the top portion of the base 115 (the section between legs (135,140) being 8.5 inches in length. In one embodiment, at the center of the base of the pageprop device 100 is a stabilizing tab 110 which is a thin plastic tab that is 1½ inches wide by 1 inch long which is inserted between the fasteners at the top of the pages in a file folder or similar item. When the pageprop device 100 is used with loosely bound material, the pageprop device 110 should be pushed in as far as it can go so that the stabilizing tab 110 can be seen sticking out of the top of the pages of the loosely bound material. This stabilizing tab 110 may be used to stabilize the pageprop device 100 and align the U shaped base to the upper edges of the viewed pages. When the pageprop device 100 is used with bound material, the stabilizing tab 110 is pushed into the bound material as far as it will go, which generally means that the outside edge of the stabilizing tab 110 is pushed up to, and makes contact with the inside portion of the binding of the bound material.

The clear plastic curved upper portion of the apparatus is the “page retainer” or retaining wall 105. This part of the pageprop device keeps the unneeded pages out of view and apart from the selected page. The angle of the retaining wall 105 also prevents the unused pages from blocking light from the user's selected page. In a preferred embodiment, the curved plastic retaining wall 105 is attached to the base by two rectangular plastic wedges (125, 130) with provide support for the retaining wall 105. These rectangular wedges (125, 130) prop the retaining wall 105 up from a 45 degree angle to a 90 degree angle.

While the invention has been particularly shown with reference to specific embodiments, it should be understood by those of ordinary skill in the art that various changes in form and detail may be made therein without departing from the spirit and scope of the invention as defined by the claims. The invention is to cover all modifications, equivalents, and alternatives falling within the spirit and scope of the invention as defined by the claims.

1. A pageprop device used to provide hands-free viewing of bound material; including:
a retaining wall wherein said retaining wall includes a curved section;
a base wherein said base includes two footers;
a stabilizing tab wherein said stabilizing tab is configured to be inserted between two pages of the bound material.

2. The pageprop device of claim 1, wherein said base includes a first and second rectangular wedge which is used to connect said retaining wall to said base.

3. The pageprop device of claim 2, wherein an angle between the footer section of the base and the top portion of the retaining wall is between 45 degrees and 90 degrees.

4. The pageprop device of claim 1 wherein said stabilizing tab is configured to extend passed the outside edge of loosely bound material.

5. The pageprop device of claim 1 wherein said stabilizing tab is configured to extend to, but not passed, the inside portion of a binding on bound material which is not loosely bound.

6. The pageprop device of claim 1 wherein the underside of each footer includes a nonslip material to reduce the chance that the pageprop device will slip after it has been inserted into bound material.

7. A pageprop device used to provide hands-free viewing of bound material; including:
a retaining wall wherein said retaining wall includes a curved section; and
a base wherein said base includes two footers.

8. The pageprop device of claim 7, wherein said base includes a first and second rectangular wedge which is used to connect said retaining wall to said base.

9. The pageprop device of claim 8, wherein an angle between the footer section of the base and the top portion of the retaining wall is between 45 degrees and 90 degrees.

10. The pageprop device of claim 7 wherein the underside of each footer includes a nonslip material to reduce the chance that the pageprop device will slip after it has been inserted into bound material.

11. A pageprop device used to provide hands-free viewing of bound material; including:
a retaining wall wherein said retaining wall includes a segmented section; and
a base wherein said base includes two footers.

12. The pageprop device of claim 11 further including a stabilizing tab wherein said stabilizing tab is configured to be inserted between two pages of the bound material.

13. The pageprop device of claim 11, wherein said base includes a first and second rectangular wedge which is used to connect said retaining wall to said base.

14. The pageprop device of claim 11, wherein an angle between the footer section of the base and the top portion of the retaining wall is between 45 degrees and 90 degrees.

15. The pageprop device of claim 11 wherein the underside of each footer includes a nonslip material to reduce the chance that the pageprop device will slip after it has been inserted into bound material.

16. The pageprop device of claim 12 wherein said stabilizing tab is configured to extend passed the outside edge of loosely bound material.

17. The pageprop device of claim 12 wherein said stabilizing tab is configured to extend to, but not passed, the inside portion of a binding on bound material which is not loosely bound.
